(19) United States
(12) Patent Application Publication
(10) Pub. No.: US 2025/0126672 A1
(43) Pub. Date: Apr. 17, 2025

(54) METHOD AND APPARATUS FOR CONDITIONAL HANDOVER IN MOBILE WIRELESS COMMUNICATION SYSTEM

(71) Applicants: Soenghun KIM, Gyeonggi-do (KR); BLACKPIN INC., Seoul (KR)

(72) Inventor: Soenghun KIM, Gyeonggi-do (KR)

(21) Appl. No.: 18/901,036

(22) Filed: Sep. 30, 2024

(30) Foreign Application Priority Data
Oct. 17, 2023 (KR) 1020230138321

(51) Int. Cl. H04W 76/20; H04W 24/10; H04W 36/36

(52) U.S. Cl. CPC H04W 76/20; H04W 24/10; H04W 36/362

(57) ABSTRACT

A method for enhancing conditional handover in network where cells with varying radio capabilities and sensitivities are deployed. The method enables providing Cell Individual Offset (CIO) values for neighbor cells in efficient and flexible way so that conditional handover is enhanced with minimum overhead both in signaling and processing.

### CROSS-REFERENCE TO RELATED APPLICATION

This application claims priority to and the benefit of Korean Patent Application No. 10-2023-0138321, filed on Oct. 17, 2023, the disclosure of which is hereby incorporated herein by reference in its entirety.

### BACKGROUND

### Technical Field

The present disclosure relates to conditional handover in wireless mobile communication system. More specifically, the present disclosure relates to enhance conditional handover performance in various cell deployments.

### Related Art

In the field of mobile communication systems, handover procedures are critical for maintaining seamless connectivity as a user equipment (UE) moves between different cells. Traditional handover mechanisms, such as those defined in earlier releases of the 3rd Generation Partnership Project (3GPP) standards, often relied on reactive processes where the network made handover decisions based on real-time measurements. These methods, while effective, were prone to handover failures due to the dynamic nature of radio environments.

To address these challenges, the concept of Conditional Handover (CHO) was introduced in 3GPP Release 16. CHO allows the UE to execute a handover when predefined conditions are met, thereby decoupling the preparation and execution phases of the handover process. This approach enhances mobility robustness by reducing the likelihood of handover failures, as the UE can make more informed decisions based on the current radio conditions.

Several studies have demonstrated the benefits of CHO in improving handover performance. For instance, CHO has been shown to significantly reduce mobility failures in high-frequency bands (FR2) and provide faster reconnection to the network after a failure1. Additionally, CHO has been successfully applied in various scenarios, including Non-Terrestrial Networks (NTN) and Integrated Access Backhaul (IAB), further highlighting its versatility and effectiveness.

Despite these advancements, there remains a need for further optimization of CHO to address specific challenges in different deployment scenarios. This includes enhancing the accuracy of condition evaluations, minimizing signaling overhead, and improving the overall efficiency of the handover process.

### SUMMARY

Aspects of the present disclosure are to enhance conditional handover performance. The method of the terminal includes receiving from a base station a radio resource control (RRC) message wherein the RRC message comprises a measurement object configuration and a measurement report configuration and one or more embedded RRC messages, performing, based on the measurement configuration, measurement for one or more measurement identities, determining, based on measurement for a measurement identity, to initiate conditional reconfiguration execution, and performing conditional reconfiguration execution to a specific cell. In case that a measurement report configuration associated with the measurement identity comprises cell individual offset (CIO) information for the specific cell, a first parameter related to CIO in the CIO information is applied to the specific cell. The specific cell is determined based on a second parameter related to physical cell identity and a third parameter related to frequency of a specific signal. The first parameter and the second parameter and the third parameter are comprised in the CIO information.

### BRIEF DESCRIPTION OF THE DRAWINGS

FIG. 1A is a diagram illustrating the architecture of an 5G system and a NG-RAN to which the disclosure may be applied.

FIG. 1B is a diagram illustrating a wireless protocol architecture in an 5G system to which the disclosure may be applied.

FIG. 2A illustrates overall operation of the UE and network.

FIG. 2B illustrates RRC connection establishment procedure.

FIG. 2C illustrates RRC connection reconfiguration procedure.

FIG. 2D illustrates data transfer procedure in RRC_CONNECTED state.

FIG. 2E illustrates RRC connection release procedure.

FIG. 3A illustrates the operation of a UE and a base station.

FIG. 3B illustrates measurement configuration.

FIG. 3C illustrates the operation of a UE and a base station for conditional reconfiguration.

FIG. 4A is a flow diagram illustrating an operation of a terminal.

FIG. 4B is a flow diagram illustrating an operation of a terminal.

FIG. 5A is a block diagram illustrating the internal structure of a UE to which the disclosure is applied.

FIG. 5B is a block diagram illustrating the configuration of a base station according to the disclosure.

### DETAILED DESCRIPTION

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, followings are used interchangeably:
Terminal and UE and wireless device;
Information Element (IE) and set of parameters;
Parameter and field and IE;
Base station and GNB;
report configuration and measurement report configuration and ReportConfigNR and ReportConfig;
measurement object configuration and measObjectNR and measObject;
measurement identity configuration and measIdToAddMod; and
cell specific offset and cell individual offset and cellIndividualOffset and CIO;
PCI and physical cell identity and PhysCellId. Layer 3 measurements are a critical component in the operation and management of New Radio (NR) systems, which form the backbone of 5G technology. These measurements provide essential data for various network functions, including handover decisions, cell reselection, and radio resource management. Accurate and timely Layer 3 measurements are vital for maintaining the quality of service (QOS) and ensuring seamless connectivity for users.

Layer 3 measurements in NR systems encompass a variety of metrics, including but not limited to:
Signal Strength: Measurements such as Reference Signal Received Power (RSRP) and Reference Signal Received Quality (RSRQ) provide insights into the signal strength and quality experienced by the user equipment (UE).
Interference Levels: Metrics like Signal-to-Interference-plus-Noise Ratio (SINR) help in assessing the level of interference in the network, which is crucial for optimizing resource allocation.
Timing Measurements: These include measurements like Round Trip Time (RTT) and Timing Advance (TA), which are essential for synchronization and handover processes.

The network configures the measurement parameters and communicates them to the UE through signaling messages. These parameters include the measurement objects, reporting criteria, and measurement intervals. The UE uses this configuration to perform the required measurements and report the results back to the network.

The UE reports the measurement results to the network based on predefined criteria. These criteria can be event-triggered or periodic. Event-triggered reporting occurs when certain conditions are met, such as a drop in signal strength below a threshold.

In New Radio (NR) systems, the measurement configuration process involves setting up parameters and procedures for measuring various radio-related quantities, such as signal strength, quality, and interference. This configuration includes three main components: Measurement Identity (measId), Measurement Object (measObject), and Report Configuration (reportConfig).

Measurement Identity (measId) is a unique identifier associated with a specific measurement configuration. It is used to link measurement configurations with measurement instances and reports. Multiple Measurement Identities can be configured simultaneously, allowing different measurement configurations to coexist. This is particularly useful in scenarios where the User Equipment (UE) needs to measure multiple cells or frequencies.

Measurement Object (measObject) defines what is being measured. It includes parameters such as the frequency or frequency range, cell identity, and physical cell identity. These parameters determine the scope and context of the measurement. In NR systems, measurements can be made on intra-frequency, inter-frequency, or intra-system (intra-RAT) cells. The Measurement Object also includes configuration parameters like the bandwidth and subcarrier spacing.

Report Configuration (reportConfig) defines how and when the measurement results should be reported. It includes parameters such as reporting mode, reporting interval, and reporting quantity. Reporting modes can be event-triggered or periodic. Event-triggered reporting occurs when a certain condition is met (e.g., a threshold is crossed), while periodic reporting involves regular, scheduled reports. Reporting intervals determine how often the measurement reports are sent, and reporting quantities specify the type of information to be included in the reports (e.g., RSRP, RSRQ, SINR). Following events are defined:
Event A1: Serving becomes better than absolute threshold;
Event A2: Serving becomes worse than absolute threshold;
Event A3: Neighbour becomes amount of offset better than PCell/PSCell;
Event A4: Neighbour becomes better than absolute threshold;
Event A5: PCell/PSCell becomes worse than absolute threshold1 AND Neighbour/SCell becomes better than another absolute threshold2;
Event A6: Neighbour becomes amount of offset better than SCell;

The relationship between measId, measObject, and reportConfig is fundamental to the measurement configuration process in NR systems:
measId: Acts as a unique identifier that links a specific measurement configuration to the measurement instances and reports. It ensures that the UE associates the correct measurement results with the corresponding configuration when sending reports to the network.
measObject: Defines the parameters of what is being measured, such as frequency, cell identity, and bandwidth. It provides the context for the measurements that the UE needs to perform.
reportConfig: Specifies how and when the measurement results should be reported, including the reporting mode, interval, and quantity. It ensures that the measurement results are communicated to the network in a timely and efficient manner.

Cell Individual Offset (CIO) is a parameter used in cellular networks to adjust the reference signal power level for each cell. This adjustment helps improve the reliability of the handover process by ensuring that mobile devices connect to the most appropriate cell tower. CIO is particularly important in NR systems, where maintaining seamless connectivity and optimal network performance is crucial.

CIO is a value that can range from −15 to +15 dB, with the default value being 0 dB. A negative CIO value indicates that the cell tower is closer to the mobile device than the reference signal power level suggests, while a positive value indicates that the cell tower is further away1. By adjusting the reference signal power level, CIO helps mobile devices identify and connect to the nearest and most suitable cell tower.

Conditional Handover (CHO) is an advanced mobility management technique introduced in 3GPP Release 16 to enhance the robustness and efficiency of handover procedures in mobile communication systems. Unlike traditional handover mechanisms, which rely on real-time decision-making, CHO decouples the preparation and execution phases of the handover process.

In CHO, the network pre-configures a set of conditional handover commands and sends them to the user equipment (UE). These commands include specific conditions that must be met for the handover to be executed. The UE continuously monitors the radio environment and evaluates these conditions. When the predefined conditions are satisfied, the UE autonomously executes the handover to the target cell.

When deploying cells with different radio capabilities and sensitivities, various cell individual cell offset values per neighbor cell would be essential. CIO for a cell is provided in the measurement object configuration associated with the cell. However, CHO is performed without measurement object.

In the present disclosure, CIO for a candidate cell can be provided in the measurement report configuration associated with the candidate cell. The base station configures appropriate CIO for the candidate cell in the associated measurement report configuration and the UE consider the CIO in determining whether to perform CHO to the candidate cell.

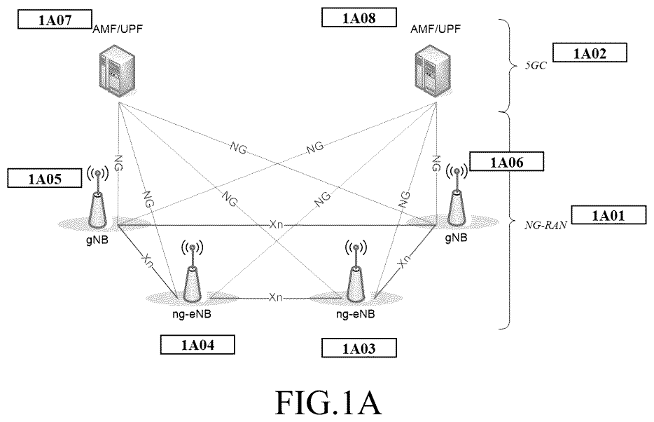

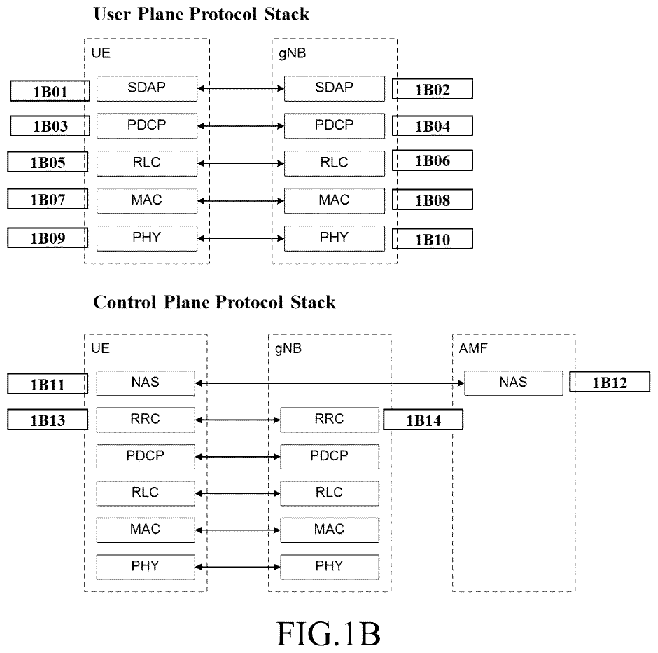

FIG. 1A is a diagram illustrating the architecture of an 5G system and a NG-RAN to which the disclosure may be applied.

5G system consists of NG-RAN 1A01 and 5GC 1A02. An NG-RAN node is either:
1: a gNB, providing NR user plane and control plane protocol terminations towards the UE; or
1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.
1: Functions for Radio Resource Management such as Radio Bearer Control, Radio Admission Control, Connection Mobility Control, Dynamic allocation of resources to UEs in uplink, downlink and sidelink (scheduling); and
1: IP and Ethernet header compression, uplink data decompression and encryption of user data stream; and
1: Selection of an AMF at UE attachment when no routing to an MME can be determined from the information provided by the UE; and
1: Routing of User Plane data towards UPF; and
1: Scheduling and transmission of paging messages; and
1: Scheduling and transmission of broadcast information (originated from the AMF or O&M); and
1: Measurement and measurement reporting configuration for mobility and scheduling; and
1: Session Management; and
1: QoS Flow management and mapping to data radio bearers; and
1: Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

FIG. 1B is a diagram illustrating a wireless protocol architecture in an 5G system to which the disclosure may be applied.

User plane protocol stack consists of SDAP 1B01 or 1B02, PDCP 1B03 or 1B04, RLC 1B05 or 1B06, MAC 1B07 or 1B08 and PHY 1B09 or 1B10. Control plane protocol stack consists of NAS 1B11 or 1B12, RRC 1B13 or 1B14, PDCP, RLC, MAC and PHY.

Each protocol sublayer performs functions related to the operations listed below.
NAS: authentication, mobility management, security control etc
RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.
SDAP: Mapping between a QoS flow and a data radio bearer, Marking QoS flow ID (QFI) in both DL and UL packets.
PDCP: Transfer of data, Header compression and decompression, Ciphering and deciphering, Integrity protection and integrity verification, Duplication, Reordering and in-order delivery, Out-of-order delivery etc.
RLC: Transfer of upper layer PDUs, Error Correction through ARQ, Segmentation and re-segmentation of RLC SDUs, Reassembly of SDU, RLC re-establishment etc.
MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.
PHY: Channel coding, Physical-layer hybrid-ARQ processing, Rate matching, Scrambling, Modulation, Layer mapping, Downlink Control Information, Uplink Control Information etc.

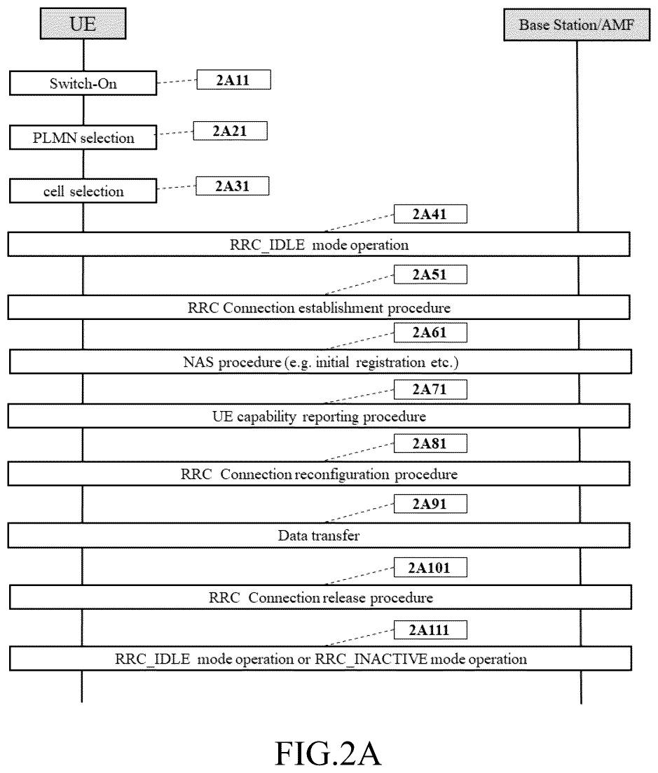

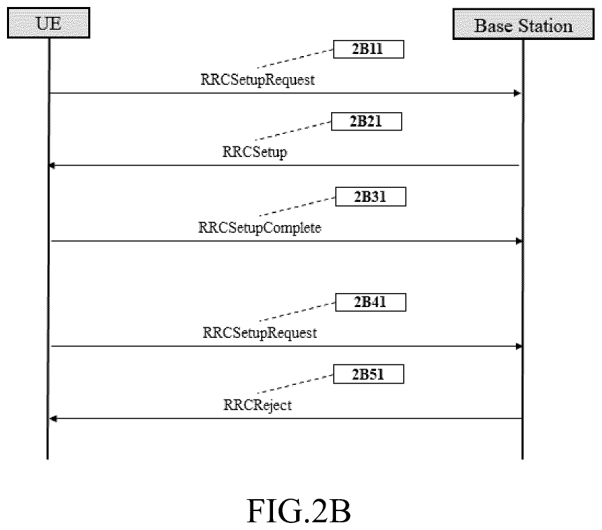

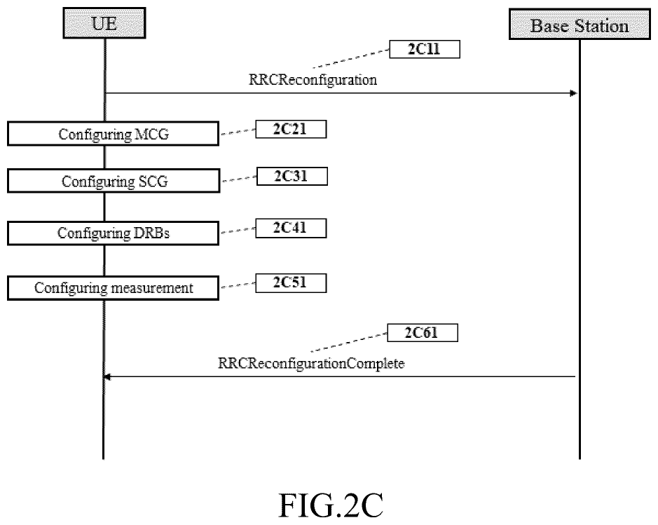

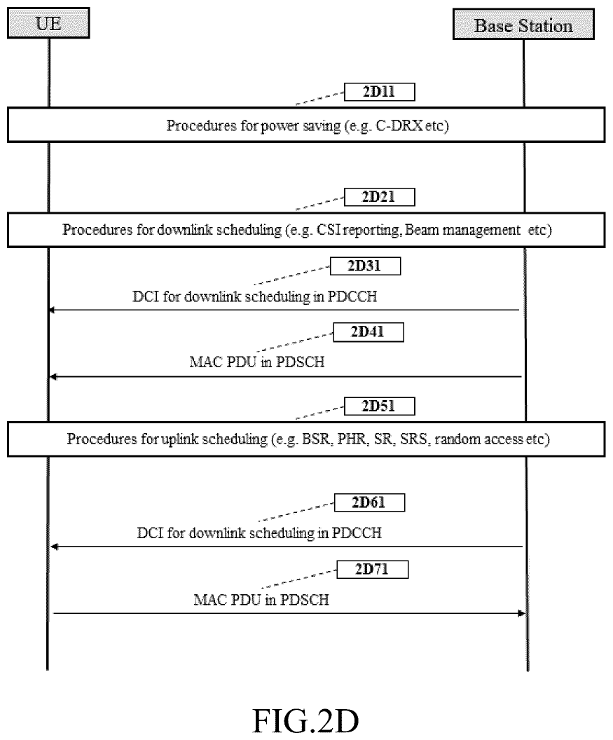

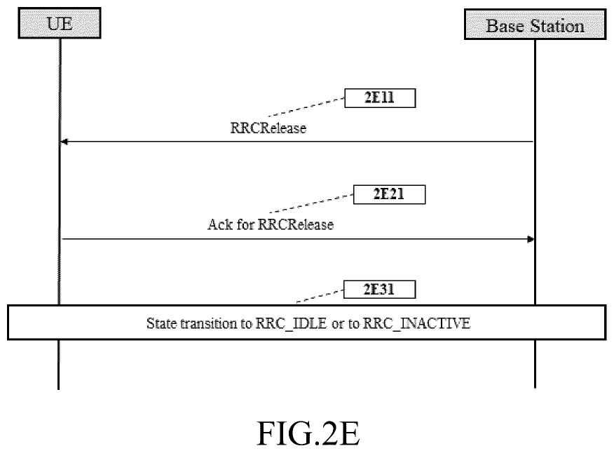

FIG. 2A illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc) and various RRC functions (such as RRM and RLM and measurement etc) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is not longer needed for the UE because of e.g. no more traffic available for the UE, the base station and the UE performs RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

FIG. 2B illustrates RRC connection establishment procedure.

Successful RRC connection establishment procedure comprises:
1: transmission of RRCSetupRequest by the UE 2B11;
1: reception of RRCSetup by the UE 2B21;
1: transmission of RRCSetupComplete by the UE 2B31.

Unsuccessful RRC connection establishment procedure comprises:
1: transmission of RRCSetupRequest by the UE 2B41;
1: reception of RRCReject by the UE 2B51;

RRCSetupRequest comprises following fields and IEs:
1: ue-Identity field contains InitialUE-Identity IE which contains:
   2: ng-5G-S-TMSI-Part1 field containing a BIT STRING of 39 bit;
1: establishmentCause field contains EstablishmentCause IE which contains:
   2 enumerated value indicating either emergency, highPriorityAccess, mt-Access, mo-Signalling, mo-Data, mo-VoiceCall, mo-VideoCall, mo-SMS, mps-PriorityAccess, mcs-Priority Access etc

RRCSetup comprises following fields and IEs:
1: radioBearerConfig field containing a RadioBearerConfig IE;
1: masterCellGroup field containing a CellGroupConfig IE.

RRCSetupComplete comprises following fields and IEs:
1: selectedPLMN-Identity field containing an integer indicating selected PLMN;
1: dedicatedNAS-Message field containing a DedicatedNAS-Message which may contain various NAS message;
1: ng-5G-S-TMSI-Part2 field containing a BIT STRING of 9 bit.

RRCSetupRequest is transmitted via CCCH/SRBO, which means that the base station does not identify UE transmitting the message based on DCI that scheduling the uplink transmission. The UE includes a field (ue-Identity) in the message so that the base station identify the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
1: perform the cell group configuration procedure in accordance with the received masterCellGroup;
1: perform the radio bearer configuration procedure in accordance with the received radioBearerConfig;
1: if stored, discard the cell reselection priority information provided by the cellReselectionPriorities or inherited from another RAT;
1: enter RRC_CONNECTED;
1: stop the cell re-selection procedure;
1: consider the current cell to be the PCell;

The UE transmits to the base station RRCSetupComplete after performing above actions.

The UE sets the contents of RRCSetupComplete message as follows:
1: set the ng-5G-S-TMSI-Value to ng-5G-S-TMSI-Part2;
1: set the selectedPLMN-Identity to the PLMN selected by upper layers from the plmn-IdentityInfoList;
1: include the s-NSSAI-List and set the content to the values provided by the upper layers;

FIG. 2C illustrates RRC connection reconfiguration procedure.

Based on the reported capability and other factors such as required QoS and call admission control etc, the base station performs RRC reconfiguration procedure with the UE.

RRC reconfiguration procedure is a general purposed procedure that are applied to various use cases such as data radio bearer establishment, handover, cell group reconfiguration, DRX configuration, security key refresh and many others.

RRC reconfiguration procedure consists of exchanging RRCReconfiguration 2C11 and RRCReconfigurationComplete 2C61 between the base station and the UE.

RRCReconfiguration may comprises following fields and IEs:
1: rrc-TransactionIdentifier field contains a RRC-TransactionIdentifier IE;
1: radioBearerConfig field contains a RadioBearerConfig IE;
   2: radioBearerConfig field comprises configuration information for SRBs and DRBs via which RRC messages and user traffic are transmitted and received;
1: secondaryCellGroup field contains a CellGroupConfig IE;
   2: secondaryCellGroup field comprises configuration information for secondary cell group;
   2: A cell group consists of a SpCell and zero or more SCells;
   2: Cell group configuration information comprises cell configuration information for SpCell/SCell and configuration information for MAC and configuration information for logical channel etc;
1: measConfig field contains a MeasConfig IE;
   2: measConfig field comprises configuration information for measurements that the UE is required to perform for mobility and other reasons.
1: masterCellGroup field contains a CellGroupConfig IE;

Upon reception of RRCReconfiguration, UE processes the IEs in the order as below. UE may:
1: perform the cell group configuration for MCG based on the received masterCellGroup 2C21;
1: perform the cell group configuration for SCG based on the received secondaryCellGroup 2C31;
1: perform the radio bearer configuration based on the received radioBearerConfig 2C41;
1: perform the measurement configuration based on the received measConfig 2C51;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

FIG. 2D illustrates data transfer procedure in RRC_CONNECTED state.

The UE and the base station may perform procedures for power saving such as C-DRX 2D11. The configuration information for C-DRX is provided to the UE within cell group configuration in the RRCReconfiguration.

The UE and the base station may perform various procedures for downlink scheduling 2D21 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 2D31. The base station transmits to the UE PDSCH corresponding to the DCI and containing a MAC PDU 2D41.

The UE and the base station may perform various procedure for uplink scheduling 2D51 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 2D61. The base station transmits to the UE PDSCH corresponding to the DCI and containing a MAC PDU 2D71.

FIG. 2E illustrates RRC connection release procedure.

RRC connection release procedure comprises:
1: transmission of RRCRelease from the base station to the UE 2E11; and
1: transmission of acknowledgement for the RRCRelease from the UE to the base station 2E21; and
1: state transition from RRC_CONNECTED to either RRC_IDLE or RRC_INACTIVE 2E31.

The purpose of RRC connection release procedure is either to release RRC connection (state transition to RRC_IDLE) or to suspend RRC connection (state transition to RRC_INACTIVE).

RRC connection release procedure may perform, in addition to state transition, various roles e.g., providing redirection information or providing cell reselection priorities.

The RRCRelease may comprise following fields for redirection:
1: redirectedCarrierInfo field comprises RedirectedCarrierInfo IE;
   2: RedirectedCarrierInfo IE comprises either CarrierInfoNR IE or RedirectedCarrierInfo-EUTRA IE;
      3: CarrierInfoNR IE comprises ARFCN-ValueNR IE and SubcarrierSpacing IE;

The UE may perform cell selection on the carrier indicated by CarrierInfoNR IE or RedirectedCarrierInfo-EUTRA IE.

The RRCRelease may comprise following fields to configure cell reselection priority:
1: cellReselectionPriorities field comprises CellReselectionPriorities IE;
   2: CellReselectionPriorities IE comprises:
      3: FreqPriorityListNR IE;
      3: t320 field indicates a timer value for cell reselection priority validity;

During idle mode mobility, the UE applies the CellReselectionPriorities until T320 expires or stops.

The RRCRelease may comprises following fields/IEs to transition UE to RRC_INACTIVE state:
1: suspendConfig field comprises SuspendConfig IE;
   2: fullI-RNTI field comprises I-RNTI-Value IE;
   2: shortI-RNTI field comprises ShortI-RNTI-Value IE;
   2: ran-PagingCycle field comprises PagingCycle IE;
   2: ran-NotificationAreaInfofield comprises RAN-NotificationAreaInfo IE;
   2: t380 field comprises PeriodicRNAU-TimerValue;
   2: nextHopChainingCount field comprises NextHopChainingCount IE.
   2: ran-ExtendedPagingCycle field comprises ExtendedPagingCycle IE.

To transit the UE to RRC_INACTIVE, the base station includes SuspendConfig IE in the RRCRelease. To transit the UE to RRC_IDLE, the base station does not include SuspendConfig IE in the RRCRelease.

Upon reception of RRCRelease, UE may:
1: delay the actions caused by RRCRelease 60 ms from the moment the RRCRelease message was received or optionally when lower layers indicate that the receipt of the RRCRelease message has been successfully acknowledged, whichever is earlier;
1: store the cell reselection priority information provided by the cellReselectionPriorities and start T320;
1: if the RRCRelease includes suspendConfig:
   2: reset MAC and release the default MAC Cell Group configuration;
   2: apply the received suspendConfig except the received nextHopChainingCount;
   2: if the sdt-Config is configured:
      3: for each of the DRB in the sdt-DRB-List, consider the DRB to be configured for SDT;
      3: if sdt-SRB2-Indication is configured, consider the SRB2 to be configured for SDT;
      3: re-establish the RLC entity for each RLC bearer that is not suspended;
      3: trigger the PDCP entity to perform SDU discard for SRB1 and SRB2;
      3: if sdt-MAC-PHY-CG-Config is configured, configure the PCell with the configured grant resources for SDT and start the cg-SDT-TimeAlignmentTimer;
      3: if srs-PosRRC-Inactive is configured, apply the configuration and instruct MAC to start the inactivePosSRS-TimeAlignmentTimer;
   2: re-establish RLC entities for SRB1;
   2: stop the timer T319 if running;
   2: store in the UE Inactive AS Context the nextHopChainingCount received in the RRCRelease message, the current KgNB and KRRCint keys, the ROHC state, the EHC context(s), the UDC state, the stored QoS flow to DRB mapping rules, the application layer measurement configuration, the C-RNTI used in the source PCell, the cellIdentity and the physical cell identity of the source PCell, the spCellConfigCommon within Reconfiguration WithSync of the NR PSCell (if configured) and all other parameters configured except for:
      3: parameters within Reconfiguration WithSync of the PCell;
      3: parameters within Reconfiguration WithSync of the NR PSCell, if configured;
      3: parameters within MobilityControlInfoSCG of the E-UTRA PSCell, if configured;
      3: servingCellConfigCommonSIB;
   2: suspend all SRB(s) and DRB(s) and multicast MRB(s), except SRB0 and broadcast MRBs;
   2: indicate PDCP suspend to lower layers of all DRBs and multicast MRBs;
   2: start timer T380, with the timer value set to t380;
   2: indicate the suspension of the RRC connection to upper layers;
   2: enter RRC_INACTIVE and perform cell selection;
1: else (if the RRCRelease does not include suspendConfig):
   2: perform the actions upon going to RRC_IDLE;

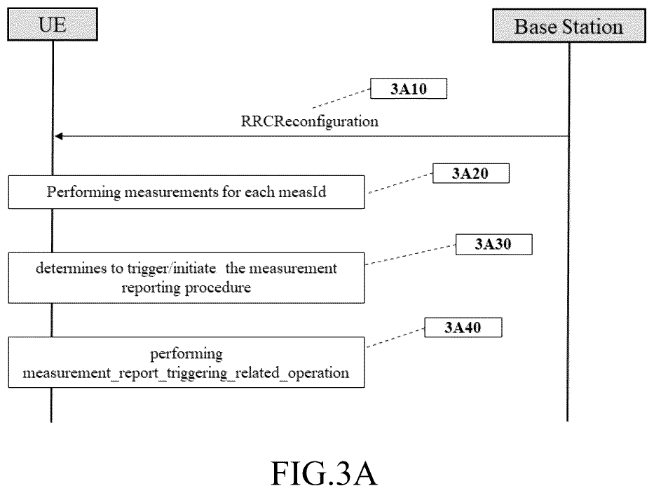

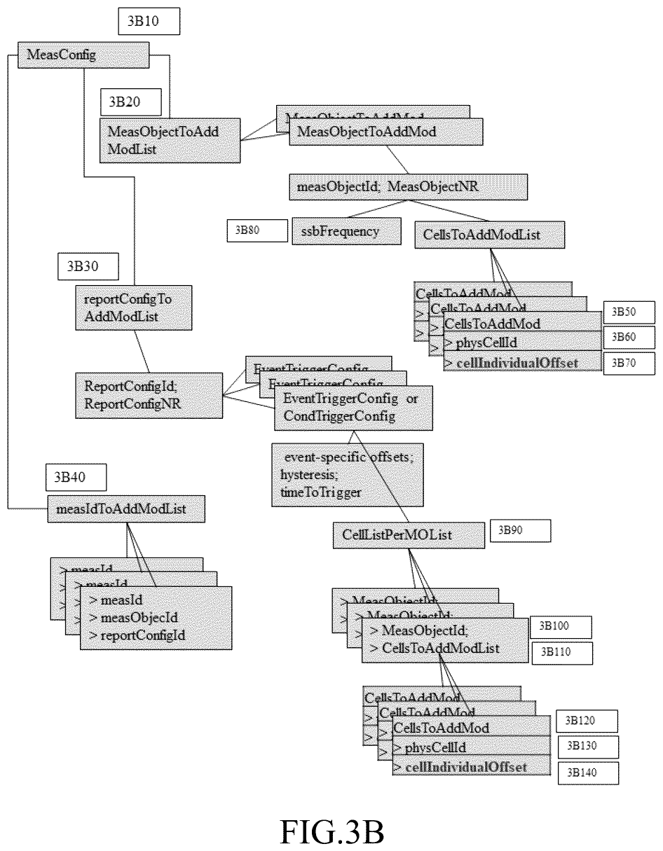

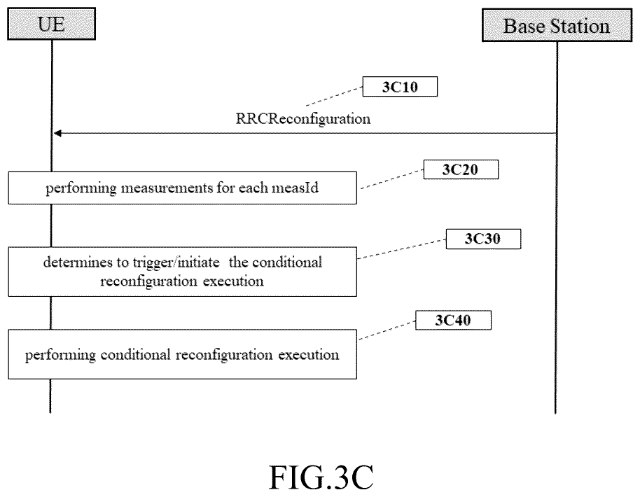

FIG. 3A illustrates operation of UE and base station to perform measurement reporting procedure.

At 3A10, GNB transmits to UE a RRCReconfiguration message. The RRCReconfiguration message comprises a MeasConfig IE. This IE comprises information about the measurement parameters, such as measurement objects, reporting criteria, and measurement gaps. UE generates and maintain VarMeasConfig and VarMeasReportList for a cell group (MCG or for SCG).

At 3A20, UE performs measurements for each measId in the measIdList within varMeasConfig for the cell group. UE measures signal strength, quality, and other relevant metrics for the specified measurement objects.

At 3A30, UE determines, for MCG or for SCG, to trigger/initiate the measurement reporting procedure based on:
: CIO configured in MeasObject or CIO configured in ReportConfig;
: measured results on the neighboring cells and serving cells; and
: measurement report configuration.

In case that a MeasId is associatd with a ReportConfig of which reportType is set to eventTriggered:
1: for a MeasId in the measIdList within varMeasConfig of the cell group; and
1: for a neighbor cell in the carrier frequency of MO (associated a measObjectId) and indicated by a PCI;
   2: if cellIndividualOffset is configured in the associated MeasObject and is configured in the associated ReportConfig; or
   2: if cellIndividualOffset is not configured in the associated MeasObject and is configured in the associated ReportConfig;
      3: UE determines, based on cellIndividualOffset in the associated ReportConfig, whether to perform measurement_report_triggering_related_operation for the neighbor cell or not;
   2: if cellIndividualOffset is configured in the associated MeasObject and is not configured in the associated ReportConfig;
      3: UE determines, based on cellIndividualOffset in the associated MeasObject, whether to perform measurement_report_triggering_related_operation for the neighbor cell or not;
   2: if cellIndividualOffset is not configured in the associated MeasObject and is not configured in the associated ReportConfig;
      3: UE determines, without considering cellIndividualOffset, whether to perform measurement_report_triggering_related_operation for the neighbor cell or not;

In case that a MeasId is associatd with a ReportConfig of which reportType is set to condTriggerConfig:
1: UE performs conditional reconfiguration evaluation;
1: UE determines, for MCG or for SCG, to perform conditional_reconfiugration_evalution_operation for a cell based on CIO configured in MeasObject or on CIO configured in ReportConfig;
1: for a MeasId in the measIdList within varMeasConfig of the cell group: and
1: for a neighbor cell in the carrier frequency of MO (associated a measObjectId) and indicated by a PCI;
   3: if cellIndividualOffset is configured in the associated MeasObject and is configured in the associated ReportConfig; or
   3: if cellIndividualOffset is not configured in the associated MeasObject and is configured in the associated ReportConfig;
   3: UE determines, based on cellIndividualOffset in the associated ReportConfig, whether to perform conditional_reconfiugration_evalution_operation for the neighbor cell or not;
   3: if cellIndividualOffset is configured in the associated MeasObject and is not configured in the associated ReportConfig;
   3: UE determines, based on cellIndividualOffset in the associated MeasObject, whether to perform conditional_reconfiugration_evalution_operation for the neighbor cell or not;
   3: if cellIndividualOffset is not configured in the associated MeasObject and is not configured in the associated ReportConfig;
   3: UE determines, without considering cellIndividualOffset, whether to perform conditional_reconfiugration_evalution_operation for the neighbor cell or not;

At 3A40, UE performs measurement_report_triggering_related_operation. UE performs followings:
1: if measurement_report_triggering_related_operation is determined to be performed for a cell, UE may:
1: if the entry condition applicable for this event, i.e. the event corresponding with the eventId of the corresponding reportConfig within VarMeasConfig, is fulfilled for the cell;
   3: include the cell in the cellsTriggredList;
   3: initiate the measurement reporting procedure;
1: if the cell is included in the cellsTriggeredList defined within the VarMeasReportList for this measId; and
1: if the leaving condition applicable for this event is fulfilled for the cell;
   3: remove the concerned cell(s) in the cellsTriggeredList defined within the VarMeasReportList for this measId;
   3: if reportOnLeave is set to true for the corresponding reporting configuration:
   3: initiate the measurement reporting procedure.
1: if conditional_reconfiugration_evalution_operation is determined to be performed for a cell, UE may:
1: consider the cell as triggered cell (target candidate cell);
1: apply the condRRCReconfig associated with the cell for conditional reconfiguration execution.

If MeasConfig is included within MRDC-SecondaryCellGroupConfig or within nr-SecondaryCellGroupConfig, UE and GNB performs the operation for SCG VarMeasConfig and SCG VarMeasReportList.

If MeasConfig is included within RRCReconfiguration-IEs, UE and GNB performs the operation for MCG VarMeasConfig and MCG VarMeasReportList.

In case that measurement reporting procedure is initiated, UE generates MeasReport message that comprises serving cell measurement results and neighboring cell measurement results. UE transmits the MeasReport message to the base station.

FIG. 3B illustrates measurement configuration information. Each rectangular in FIG. 3B is an IE or a field.

The MeasConfig IE 3B10 comprises following IEs/fields:
: measObjectToAddModList 3B20 which comprises MeasObjectToAddModList;
: reportConfigToAddModList 3B30 which comprises ReportConfigToAddModList; and
: measIdToAddModList 3B40 which comprises MeasIdToAddModList.

MeasIdToAddModList contains one or more MeasIdToAddMod. A MeasIdToAddMod IE comprises:
: measId field;
: measObjectId field that indicates measurement object associated with the measurement identity; and
: reportConfigId field that indicates report configuration associated with the measurement identity.

MeasObjectToAddModList comprises one or more MeasObjectToAddMod. A MeasObjectToAddMod comprises a measObjectId and MeasObjectNR. A MeasObjectNR comprises:
: cellsToAddModList field that indicates a list of cells to add/modify in the cell list. This field comprises one or more CellsToAddMod IEs 3B50. Each CellsToAddMod IE comprises:
   : physCellId field 3B60 that comprises PhysCellId IE; and
   : cellIndividualOffset field 3B70 that comprises Q-OffsetRangeList;
   : ssbFrequency field 3B80 that comprises ARFCN-ValueNR IE:
   this field indicates the frequency of the Synchronization signal (SS) or SSB associated to this MeasObjectNR;
: freqBandIndicatorNR that indicates the frequency band in which the SSB and/or CSI-RS indicated in this MeasObjectNR are located and according to which the UE shall perform the RRM measurements.
: offsetMO field that indicates offset values applicable to all measured cells with reference signal(s) indicated in this MeasObjectNR.

RepoortConfigToAddModList 3B30 comprises one or more ReportConfigToAddMod IEs. A ReportConfigToAddMod IE comprises ReportConfigId and ReportConfigNR. A ReportConfigNR comprises a reportType field that indicates type of configured measurement report. If the ReportConfigNR is to configure event-triggered report, the reportType field comprises an eventTriggered field. The eventTriggered field comprises following fields;
: event specific parameters:
   : a3-Offset/a6-Offset field that indicates offset value(s) to be used in NR measurement report triggering condition for event a3/a6. The actual value is field value*0.5 dB;
   : aN-ThresholdM field that indicates threshold value associated to the selected trigger quantity to be used in NR measurement report triggering condition for the concerned event.
   : reportOnLeave field that indicates whether or not the UE shall initiate the measurement reporting procedure when the leaving condition is met for a cell in cellsTriggeredList;
   : timeToTrigger field that indicates time during which specific criteria for the event needs to be met in order to trigger a measurement report;
: CelllListPerMOList field that provide additional cellIndividualOffsets. This field comprises one or more pairs of following fields:
   : MeasObjectId 3B100 field that indicates (corresponds to) ssbFrequency of the associated measurement object.
   : CellToAddModList field 3B110 that indicates CellToAddMod that are associated with the MeasObjectId.

If the ReportConfigNR is to configure conditional reconfiguration evaluation, the reportType field comprises an CondTriggerConfig IE. The CondTriggerConfig IE comprises following fields;
: conditional event specific parameters such as various offsets and various threshold and timeToTrigger etc;
: CellListPerMOList field 3B90 that provide additional cellIndividualOffsets. This field comprises one or more pairs of following fields.

Each cellIndividualOffset 3B140 comprised in CellsToAddModList 3B110 is cell individual offset for a neighboring cell indicated by:
: the physCellId (Physical Cell Identity) 3B130 in the CellsToAddMod IE 3B120 of CellToAddModList 3B110 IE where the cellIndividualOffset 3B140 is comprised; and
: ssbFrequency corresponding to MeasObject that is indicated by MeasObjectId 3B100 associated with the CellToAddModList 3B110 that comprises CellToAddMod where the physCellId field is comprised.

CelllListPerMOList field is optionally present, Need M, if reportType is event A3 or event A5 or event A6. Otherwise (A1, A2 or A4), it is absent, Need R.

CelllListPerMOList field can be present in ReportConfig if reportType is event A3 or event A5 or event A6.

CelllListPerMOList field is absent in ReportConfig if reportType is event A1 or event A2 or event A4.

FIG. 3C illustrates operation of UE and base station to perform conditional reconfiguration execution.

Conditional handover is a mechanism that enhances the reliability and efficiency of handover processes. It involves pre-configuring multiple potential target cells for handover based on specific conditions. The User Equipment (UE) continuously monitors these conditions, such as signal strength, quality, and other relevant parameters. When the predefined conditions are met, the UE initiates the handover to the most suitable target cell.

The specific condition is defined by one or two measurement identities. The criteria that determines whether the condition is fulfilled or not is defined for the current serving cell and the candidate cell. It means that measurement object associated with the measurement identity is not used for the evaluation. To configure cell individual offset for a candidate cell, cell individual offset can be signaled in the report configuration associated with the measurement identity. In case that the cell individual offset is signaled for conditional reconfiguration, unlike measurement reporting case, cell individual offset in the associated measurement object configuration is ignored regardless of whether or not cell individual offset is configured in the associated report configuration.

At 3C10, GNB transmits to UE a RRCReconfiguration message. The RRCReconfiguration message comprises a MeasConfig IE. This IE comprises information about the measurement parameters, such as measurement objects, reporting criteria, and measurement gaps. UE generates and maintain VarMeasConfig and VarMeasReportList for a cell group (MCG or for SCG).

The RRCReconfiguration message comprises a CondReconfigToAddModList IE. The CondReconfigToAddModList IE comprises one or more CondReconfigToAddMod IEs, wherein each of one or more CondReconfigToAddMod IEs corresponds to a candidate cell (or candidate configuration). CondReconfigToAddMod IE comprises one or two MeasId IEs (that defines execution conditions) and condRRCReconfig field (that contains RRCReconfiguration for the candidate/target configuration).

At 3C20, UE performs measurements for each measId in the measIdList within varMeasConfig for the cell group. UE measures signal strength, quality, and other relevant metrics for the specified measurement objects.

At 3C30, UE determines, for MCG or for SCG, to trigger/initiate the conditional reconfiguration execution based on:
: CIO configured in associated ReportConfig;
: measured results on the candidate cell and serving cells; and
: measurement report configuration.

In case that a MeasId is associatd with a ReportConfig of which reportType is set to CondTriggerConfig:
1: for a MeasId in the measIdList within varMeasConfig of the cell group; and
1: for a candidate cell of the condRRCReconfig;
   2: if cellIndividualOffset is configured in the associated MeasObject and is configured in the associated ReportConfig; or
   2: if cellIndividualOffset is not configured in the associated MeasObject and is configured in the associated ReportConfig;
      3: UE determines, based on cellIndividualOffset in the associated ReportConfig, whether to perform the conditional_reconfiugration_evalution_operationfor candidate/applicable cell or not;
   2: if cellIndividualOffset is configured in the associated MeasObject and is not configured in the associated ReportConfig; and
   2: if cellIndividualOffset is not configured in the associated MeasObject and is not configured in the associated ReportConfig;
      3: UE determines, without considering cellIndividualOffset, whether to perform conditional_reconfiugration_evalution_operation for the candidate cell or not.

candidate cell of the condRRCReconfig is a cell which has a physical cell identity matching the value indicated in the ServingCellConfigCommon included in the reconfiguration WithSync within the masterCellGroup in the received condRRCReconfig.

At 3C40, UE performs conditional reconfiguration execution:
1: consider the candidate cell as triggered cell (target candidate cell);
1: apply the condRRCReconfig associated with the cell for conditional reconfiguration execution.

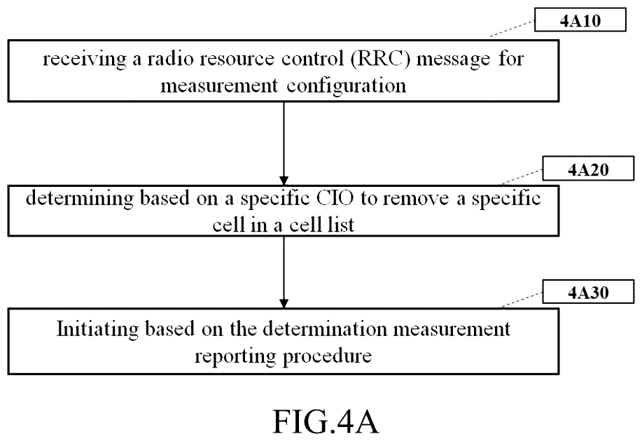

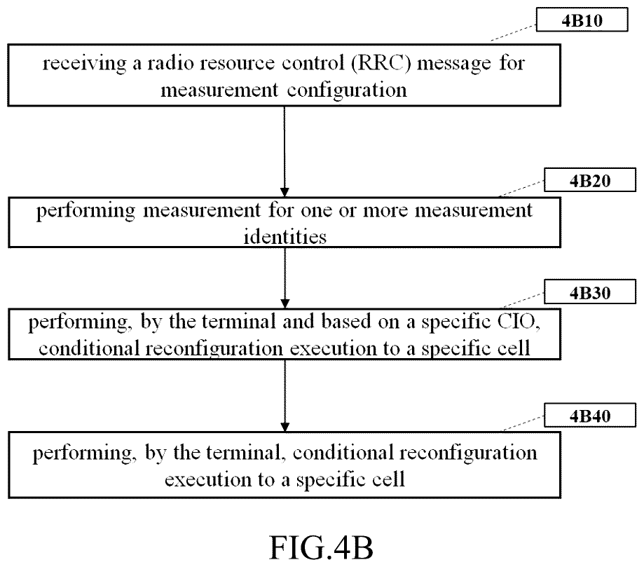

FIG. 4A is a flow diagram illustrating an operation of a terminal.

UE performs followings for measurement report.
1: receiving by the terminal from a base station a radio resource control (RRC) message 4A10, wherein the RRC message comprises:
   2: a measurement object configuration, wherein the measurement object configuration comprises a first information [CellsToAddModList], wherein the first information comprises one or more CIOs, and wherein each of the one or more CIOs in the first information is associated with a physical cell identity; and
   2: a measurement report configuration, wherein the measurement report configuration comprises a second information [CelllListPerMOList; cellIndividualOffsetList], and wherein the second information comprises one or more CIOs, and wherein each of the one or more CIOs in the second information is associated with physical cell identity and frequency of synchronization signal (SS);
      3: physical cell identity is determined by a first parameter 3B130 in the second information 3B90; and
      3: frequency of SS is determined by a second parameter 3B100 in the second information 3B90;
1: determining, by the terminal based on a specific CIO, to remove a specific cell in a cell list [cellsTriggeredList] 4A20; and
1: initiating, by the terminal and based on the determination, measurement reporting procedure 4A30 in case that:
   2: a specific indication [reportOnLeave] is comprised in the measurement report configuration; and
   2: the specific indication is set to a specific value,
1: wherein the specific CIO is determined based on the second information in case that the specific cell is indicated in the second information and in the first information.
1: wherein the specific CIO is determined based on the first information in case that the specific cell is not indicated in the second information and indicated in the first information.
1: wherein the measurement object configuration and the measurement report configuration are associated by a specific measurement identity.
1: wherein, in case that the specific CIO is determined based on the second information:
   2: a CIO associated with a specific physical cell identity and a specific frequency of SS is the specific CIO;
   2: the specific physical cell identity is physical cell identity of the specific cell;
   2: the specific frequency of SS is a frequency of SS of the specific cell;
   2: the specific physical cell identity and the specific frequency of SS are determined based on parameters in the second information.
1: wherein, in case that the specific CIO is determined based on the first information:
   2: a CIO associated with a specific physical cell identity is the specific CIO;
   2: the specific physical cell identity is physical cell identity of the specific cell;
   2: the specific physical cell identity is determined based on parameter in the first information.
1: CIO for the specific cell in the second information is applied in case that:
   2: CIO for the specific cell is comprised in the first information; and
   2: CIO for the specific cell is comprised in the second information;
1: CIO for the specific cell in the first information is applied in case that:
   2: CIO for the specific cell is comprised in the first information; and
   2: CIO for the specific cell is not comprised in the second information.

UE may perform followings:
1: receiving by the terminal from a base station a radio resource control (RRC) message, wherein the RRC message comprises a measurement configuration;

The cellsTriggeredList is a data structure utilized in NR (New Radio) technology to maintain a list of cells that have been triggered for measurement reporting. This list is dynamically updated based on the network's configuration and the UE's (User Equipment) measurement results. When a measurement report is triggered due to a cell, information related to the cell (e.g. PCI) is included in the cellsTriggeredList. The primary purpose of the cellsTriggeredList is to ensure efficient and timely reporting of measurement data.

The reportOnLeave is a parameter used in NR (New Radio) technology to control the reporting behavior of the UE (User Equipment) when it leaves a configured measurement area. This parameter ensures that the UE sends a measurement report to the network when it detects that it is leaving the area defined by the network.

The Synchronization Signal Block (SSB) is a fundamental component in NR (New Radio) systems. The SSB consists of two main parts: the Primary Synchronization Signal (PSS) and the Secondary Synchronization Signal (SSS), along with the Physical Broadcast Channel (PBCH).
: Primary Synchronization Signal (PSS): Helps the user equipment (UE) to achieve time and frequency synchronization with the network.
: Secondary Synchronization Signal (SSS): Provides additional synchronization information and helps in cell ID detection.
: Physical Broadcast Channel (PBCH): Carries essential system information required for the UE to access the network.

The SSB is transmitted periodically and is crucial for the initial access procedure, enabling the UE to detect and synchronize with the NR cell.

PSS and SSS are denoted as SS.

For conditional reconfiguration evaluation, UE performs followings:
1: for each measId that is associated with ReportConfigNR of which reportType is set to condTriggerConfig,
   2: if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
      3: consider the event associated to that measId to be fulfilled;

The entry condition applicable for this event associated with the condReconfigId is evaluated considering cell individual offset associate with the candidate cell.

Cell individual offset associated with a candidate cell is determined based on:
MeasId associated with the candidate cell;
ReportConfigId associated with the MeasId;
ssbFreqeucny of measurement object associated with CellListPerMOList in the ReportConfigNR (indicated by ReportConfigId); and
physCellId in CellListPerMOList in the ReportConfigNR.

UE consider the cell individual offset of which physCellId and ssbFrequency are identical to that of candidate cell as CIO for the candidate cell.

For conditional event A3, The UE shall:
: consider the entering condition for this event to be satisfied when condition A3-1 is fulfilled.

$$Mn + Ofn + Ocn - Hys > Mp + Ofp + Ocp + Off \qquad Inequality A3 - 1 ( Entering condition )$$

The variables in the formula are defined as follows:
Mn is the measurement result of the candidate cell, not taking into account any offsets.
Ofn is the measurement object specific offset of the reference signal of the candidate cell (i.e. offsetMO as defined within measObjectNR corresponding to the neighbour cell).
Ocn is the cell specific offset of the candidate cell (i.e. cellIndividualOffset as defined within within ReportConfigNR), and set to zero if not configured for the neighbour cell.
Mp is the measurement result of the SpCell, not taking into account any offsets.
Ofp is the measurement object specific offset of the SpCell (i.e. offsetMO as defined within measObjectNR corresponding to the SpCell).
Ocp is the cell specific offset of the SpCell (i.e. cellIndividualOffset as defined within measObjectNR corresponding to the SpCell), and is set to zero if not configured for the SpCell.
Hys is the hysteresis parameter for this event (i.e. hysteresis as defined within reportConfigNR for this event).
Off is the offset parameter for this event (i.e. a3-Offset as defined within reportConfigNR for this event).
Mn, Mp are expressed in dBm in case of RSRP, or in dB in case of RSRQ and RS-SINR.
Ofn, Ocn, Ofp, Ocp, Hys, Off are expressed in dB.

For conditional event A4, the UE shall:
: consider the entering condition for this event to be satisfied when condition A4-1, as specified below, is fulfilled.

$$Mn + Ofn + Ocn - Hys > Thresh \qquad Inequality A4 - 1 ( Entering condition )$$

The variables in the formula are defined as follows:
Mn is the measurement result of the candidate cell
Ofn is the measurement object specific offset of the neighbour cell (i.e. offsetMO as defined within measObjectNR corresponding to the neighbour cell).
Ocn is the measurement object specific offset of the neighbour cell (i.e. cellIndividualOffset for the candidate cell as defined within within reportConfigNR), and set to zero if not configured for the candidate cell.
Hys is the hysteresis parameter for this event (i.e. hysteresis as defined within reportConfigNR for this event).
Thresh is the threshold parameter for this event (i.e. a4-Threshold as defined within reportConfigNR for this event).
Mn is expressed in dBm in case of RSRP, or in dB in case of RSRQ and RS-SINR.
Ofn, Ocn, Hys are expressed in dB.
Thresh is expressed in the same unit as Mn.

FIG. 4B is a flow diagram illustrating an operation of a terminal for conditional reconfiguration.

UE performs followings for conditional reconfiguration.
1: receiving by the terminal from a base station a radio resource control (RRC) message 4B10, wherein the RRC message comprises:
   2: a measurement object configuration, wherein the measurement object configuration comprises a first information [CellsToAddModList], wherein the first information comprises one or more CIOs, and wherein each of the one or more CIOs in the first information is associated with a physical cell identity; and
   2: a measurement report configuration, wherein the measurement report configuration comprises a second information [CelllListPerMOList; cellIndividualOffsetList], and wherein the second information comprises one or more CIOs, and wherein each of the one or more CIOs in the second information is associated with physical cell identity and frequency of synchronization signal (SS);
      3: physical cell identity is determined by a first parameter 3B130 in the second information 3B90; and
      3: frequency of SS is determined by a second parameter 3B100 in the second information 3B90;
1: performing, by the terminal and based on the measurement configuration, measurement for one or more measurement identities 4B20;
1: determining, by the terminal based on measurement for a measurement identity, to initiate conditional reconfiguration execution 4B30; and
1: performing, by the terminal, conditional reconfiguration execution to a specific cell 4B40,
1: wherein, in case that a measurement report configuration associated with the measurement identity comprises CIO information for the specific cell:
   2: a first parameter related to CIO in the CIO information is applied to the specific cell;
   2: the specific cell is determined based on:
      3: a second parameter related to physical cell identity; and
      3: a third parameter related to frequency of a specific signal; and
   2: the first parameter and the second parameter and the third parameter are comprised in the CIO information for the one or more neighbour cell.

An embedded RRC message that comprises configuration of the specific cell is applied in case that condition reconfiguration execution to the specific cell is performed.

Physical cell identity indicated by the second parameter is identical to a physical cell identity of the specific cell.

The physical cell identity of the specific cell is indicated in serving cell configuration comprised in an embedded RRC message associated with the specific cell.

The terminal determines to initiate conditional reconfiguration execution for the specific cell based on the measurement identity in case that:
the measurement identity is associated with a conditional event; and
an entry condition of the conditional event is fulfilled during a specific time duration.

The entry condition of the conditional event is fulfilled in case that a first value is greater than a second value.

The first value is sum of measurement result of the specific cell and a specific CIO.

The second value is sum of measurement result of a special cell and a frequency specific offset and a second CIO.

The specific CIO is determined based on the first parameter in the measurement reporting configuration.

The second CIO is determined based on a parameter in measurement object configuration.

UE performs followings:
receiving by the terminal from a base station a radio resource control (RRC) message, wherein the RRC message comprises a measurement configuration;
performing, by the terminal and based on the measurement configuration, measurement for one or more measurement identities;
determining, by the terminal for a measurement identity, to initiate conditional reconfiguration execution; and
transmitting, by the terminal to the base station, a measurement report message,
wherein, in case that a measurement report configuration associated with the measurement identity comprises a first cell individual offset (CIO) information, a first parameter related to CIO is applied to a specific neighbour cell,
wherein the specific neighbour cell is determined based on:
   a second parameter related to physical cell identity; and
   a third parameter related to frequency of a specific signal, and
wherein the first parameter and the second parameter and the third parameter are comprised in the first CIO information in the measurement report configuration.

The measurement report message comprises:
the measurement identity; and
a measurement result of the neighbour cell.

The measurement configuration comprises:
a measurement object configuration, wherein the measurement object configuration comprises a second CIO information, wherein the second CIO information comprises one or more cell individual offsets (CIOs), and wherein each of the one or more CIOs in the first information is associated with a physical cell identity; and
a measurement report configuration, wherein the measurement report configuration comprises the first CIO information, wherein the second information comprises one or more CIOs, and wherein each of the one or more CIOs in the second information is associated with a physical cell identity and a frequency of synchronization signal (SS).

In case that a measurement report configuration associated with the measurement identity does not comprises a first cell individual offset (CIO) information, a second parameter related to CIO is applied to a specific neighbour cell.

The second parameter related to CIO is comprised in the measurement object configuration.

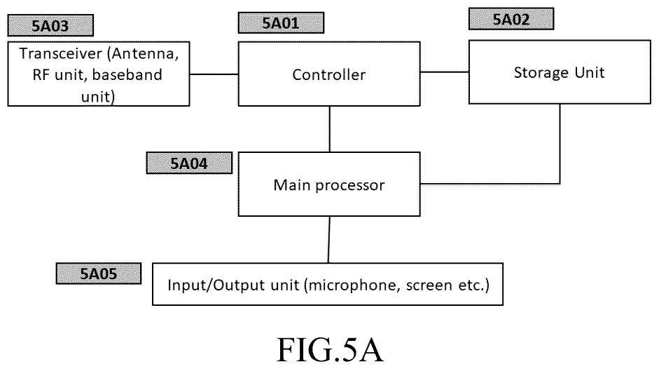

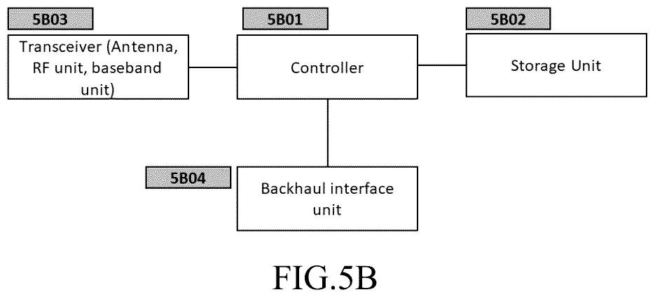

FIG. 5A is a block diagram illustrating the internal structure of a UE to which the disclosure is applied.

Referring to the diagram, the UE includes a controller 5A01, a storage unit 5A02, a transceiver 5A03, a main processor 5A04 and I/O unit 5A05.

The controller 5A01 controls the overall operations of the UE in terms of mobile communication. For example, the controller 5A01 receives/transmits signals through the transceiver 5A03. In addition, the controller 5A01 records and reads data in the storage unit 5A02. To this end, the controller 5A01 includes at least one processor. For example, the controller 5A01 may include a communication processor (CP) that performs control for communication and an application processor (AP) that controls the upper layer, such as an application program. The controller controls storage unit and transceiver such that UE operations in the present disclosure are performed.

The storage unit 5A02 stores data for operation of the UE, such as a basic program, an application program, and configuration information. The storage unit 5A02 provides stored data at a request of the controller 5A01.

The transceiver 5A03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor 5A04 controls the overall operations other than mobile operation. The main processor 5A04 process user input received from I/O unit 5A05, stores data in the storage unit 5A02, controls the controller 5A01 for required mobile communication operations and forward user data to I/O unit 5A05.

I/O unit 5A05 consists of equipment for inputting user data and for outputting user data such as a microphone and a screen. I/O unit 5A05 performs inputting and outputting user data based on the main processor's instruction.

FIG. 5B is a block diagram illustrating the configuration of a base station according to the disclosure.

As illustrated in the diagram, the base station includes a controller 5B01, a storage unit 5B02, a transceiver 5B03 and a backhaul interface unit 5B04.

The controller 5B01 controls the overall operations of the main base station. For example, the controller 5B01 receives/transmits signals through the transceiver 5B03, or through the backhaul interface unit 5B04. In addition, the controller 5B01 records and reads data in the storage unit 5B02. To this end, the controller 5B01 may include at least one processor. The controller controls transceiver, storage unit and backhaul interface such that base station operation in the present disclosure.

The storage unit 5B02 stores data for operation of the main base station, such as a basic program, an application program, and configuration information. Particularly, the storage unit 5B02 may store information regarding a bearer allocated to an accessed UE, a measurement result reported from the accessed UE, and the like. In addition, the storage unit 5B02 may store information serving as a criterion to deter mine whether to provide the UE with multi-connection or to discontinue the same. In addition, the storage unit 5B02 provides stored data at a request of the controller 5B01.

The transceiver 5B03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit 5B04 provides an interface for communicating with other nodes inside the network. The backhaul interface unit 5B04 converts a bit string transmitted from the base station to another node, for example, another base station or a core network, into a physical signal, and converts a physical signal received from the other node into a bit string.

What is claimed is:

1. A method performed by a terminal, the method comprising:
receiving by the terminal from a base station a radio resource control (RRC) message, wherein the RRC message comprises a measurement configuration and one or more embedded RRC messages;
performing, by the terminal based on the measurement configuration, measurement for one or more measurement identities;
determining, by the terminal based on measurement for a measurement identity, to initiate conditional reconfiguration execution; and
performing, by the terminal, conditional reconfiguration execution to a specific cell,
wherein, in case that a measurement report configuration associated with the measurement identity comprises cell individual offset (CIO) information for the specific cell, a first parameter related to CIO in the CIO information is applied to the specific cell,
wherein the specific cell is determined based on:
a second parameter related to physical cell identity; and
a third parameter related to frequency of a specific signal, and
wherein the first parameter, the second parameter, and the third parameter are comprised in the CIO information.

2. The method of claim 1,
wherein an embedded RRC message that comprises configuration of the specific cell is applied in case that condition reconfiguration execution to the specific cell is performed.

3. The method of claim 1, wherein:
physical cell identity indicated by the second parameter is identical to a physical cell identity of the specific cell; and
the physical cell identity of the specific cell is indicated in serving cell configuration comprised in an embedded RRC message associated with the specific cell.

4. The method of claim 1, wherein:
the terminal determines to initiate conditional reconfiguration execution for the specific cell based on the measurement identity in case that:
the measurement identity is associated with a conditional event; and
an entry condition of the conditional event is fulfilled during a specific time duration.

5. The method of claim 4, wherein:
the entry condition of the conditional event is fulfilled in case that a first value is greater than a second value;
the first value is sum of measurement result of the specific cell and a specific CIO; and
the second value is sum of measurement result of a special cell, a frequency specific offset, and a second CIO.

6. The method of claim 5, wherein:
the specific CIO is determined based on the first parameter in the measurement report configuration; and
the second CIO is determined based on a parameter in a measurement object configuration.

7. A method performed by a terminal, the method comprising:
receiving by the terminal from a base station a radio resource control (RRC) message, wherein the RRC message comprises a measurement configuration;
performing, by the terminal based on the measurement configuration, measurement for one or more measurement identities;
determining, by the terminal for a measurement identity, to initiate conditional reconfiguration execution; and
transmitting, by the terminal to the base station, a measurement report message,
wherein, in case that a measurement report configuration associated with the measurement identity comprises a first cell individual offset (CIO) information, a first parameter related to CIO is applied to a specific neighbour cell,
wherein the specific neighbour cell is determined based on:
a second parameter related to physical cell identity; and
a third parameter related to frequency of a specific signal, and
wherein the first parameter, the second parameter, and the third parameter are comprised in the first CIO information in the measurement report configuration.

8. The method of claim 7,
wherein the measurement report message comprises:
the measurement identity; and
a measurement result of the specific neighbour cell.

9. The method of claim 7,
wherein the measurement configuration comprises:
a measurement object configuration, wherein the measurement object configuration comprises a second CIO information, wherein the second CIO information comprises one or more cell individual offsets (CIOs), and wherein each of the one or more CIOs in the first information is associated with a physical cell identity; and
a measurement report configuration, wherein the measurement report configuration comprises the first CIO information, wherein the first CIO information comprises one or more CIOs, and wherein each of the one or more CIOs in the first CIO information is associated with a physical cell identity and a frequency of synchronization signal (SS).

10. The method of claim 7,
wherein, in case that the measurement report configuration associated with the measurement identity does not comprise the first CIO information, a fourth parameter related to CIO is applied to the specific neighbour cell.

11. The method of claim 10,
wherein the fourth parameter related to CIO is comprised in a measurement object configuration.

12. A terminal comprising:
a transceiver,
a memory, and
a controller coupled to the transceiver and the memory, wherein the controller is configured to cause the terminal to:
receive from a base station a radio resource control (RRC) message, wherein the RRC message comprises a measurement configuration and one or more embedded RRC messages;
perform, based on the measurement configuration, measurement for one or more measurement identities;
determine, based on measurement for a measurement identity, to initiate conditional reconfiguration execution; and
perform conditional reconfiguration execution to a specific cell,
wherein, in case that a measurement report configuration associated with the measurement identity comprises cell individual offset (CIO) information for the specific cell, a first parameter related to CIO in the CIO information is applied to the specific cell,
wherein the specific cell is determined based on:
a second parameter related to physical cell identity; and
a third parameter related to frequency of a specific signal, and
wherein the first parameter, the second parameter, and the third parameter are comprised in the CIO information.
